(19) United States
(12) Patent Application Publication
(10) Pub. No.: US 2008/0162411 A1
(43) Pub. Date: Jul. 3, 2008

(54) APPARATUS, SYSTEM, AND METHOD FOR AUTONOMICALLY ANALYZING A DATABASE MANAGEMENT SYSTEM

(75) Inventors: Andrew David Buckler, Markham (CA); Daniel Liviu Deaconu, Richmond Hill (CA); John Frederick Hornibrook, Markham (CA)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, ARMONK, NY (US)

(21) Appl. No.: 11/617,457

(22) Filed: Dec. 28, 2006

(51) Int. Cl. G06F 17/30

(52) U.S. Cl. 707/2

(57) ABSTRACT

An apparatus, system, and method are disclosed for autonomically analyzing a database management system (DBMS). This is accomplished by recording database commands in a datastore while imposing minimal performance effects on the database management system. Then, an optimal playback window is determined for replaying the recorded database commands while imposing minimal performance effects on the DBMS. The recorded database commands are replayed during the determined optimal playback window, and performance statistics are gathered in response to the replayed database commands. The gathered performance statistics are sent to one or more autonomic consumer applications which are responsible for optimizing the DBMS.

### BACKGROUND OF THE INVENTION

1. Field of the Invention

This invention relates to autonomic database technology and more particularly relates to the autonomic self-optimization of database management systems.

2. Description of the Related Art

Autonomic technology generally requires large amounts of data regarding the performance of a system. Such large amounts of data can be costly to accumulate and analyze. Self-optimization technology in particular can require testing numerous theoretical configurations to determine the most efficient set up possible for a system. However, gathering performance data, particularly the speculative variety, can add too much overhead at runtime to be feasible. Data gathering tasks make self-optimization less effective because of their negative effect on the overall performance of a system. Thus, conventional art that attempts to gather system performance statistics in real time fails to provide an adequate means for self-optimization, because such solutions adversely affect the performance of the system.

With regard to database systems, one solution to overcome the performance affects of real time data gathering is to record a workload comprised of database commands for analyzing at a later time. By analyzing the stored database commands, some information about the system can be extracted without adversely affecting the performance of a system. However, simply analyzing the database commands does not necessarily provide an accurate reflection of the system's performance needs. A much more accurate representation of a system's performance needs can be obtained by actually running the database commands through the system, perhaps at a later time when the system performance would not be degraded for a user.

Another possible solution is to run only a few of the database commands through the system. Then, information could be gathered regarding these commands with only a slight reduction in overall system performance. The data could then be used to predict how other database commands might affect the system. However, this solution would also be much less accurate than actually running all of the database commands of interest, and thus does not allow for maximum optimization of the system. Again, such a problem may be overcome by storing database commands and replaying them at an optimal time.

Thus, a need exists for a database management system that autonomically replays database commands at a later time, such as during a low usage period of the system. Furthermore, a need exists for a system that autonomically determines an optimal window for playback of the database commands so as to impose minimal effects on the performance of the database system.

### SUMMARY OF THE INVENTION

Given the foregoing discussion, Applicant asserts that a need exists for an apparatus, system, and method that autonomically analyzes a database management system (DBMS). Beneficially, such an apparatus, system, and method would autonomically provide performance statistics to consumer applications such that the database management system can be optimized. As used herein, the term “consumer application” means a software application configured to request and make use of performance statistics for database commands that are executed in a database management system. Typically, a consumer application is some type of optimization module used to identify less efficient database commands or DBMS configurations for the DBMS. Often, a consumer application operates autonomically.

The present invention has been developed in response to the present state of the art, and in particular, in response to the problems and needs in the art that have not yet been fully solved by currently available database management systems. Accordingly, the present invention has been developed to provide an apparatus, system, and method for autonomically analyzing a database management system during an optimal workload window that overcomes many or all of the above-discussed shortcomings in the art.

The apparatus to autonomically analyze a database management system is provided with a plurality of modules configured to functionally execute the necessary steps of autonomically analyzing a database management system. These modules in the described embodiments include a recorder module, a schedule module, a workload playback module, and a statistics module.

The recorder module is configured to record database commands in a datastore as the database commands are issued such that the recorder module imposes minimal performance impacts on the database management system.

The schedule module is configured to determine an optimal playback window for replaying the recorded database commands.

The workload playback module is configured to read the recorded database commands and replay the database commands during the determined optimal playback window. The workload playback module may be further configured to filter the database commands in response to user-defined preferences such that only relevant database commands are replayed. The workload playback module may be further configured to receive statistic requests from a consumer application such that relevant performance statistics are returned to that consumer application. Additionally, the workload playback module may be further configured to aggregate requests from the consumer applications such that multiple statistic requests are serviced by a single replay of the database commands. In one embodiment, the workload playback module is further configured to manipulate the database commands such that modified database commands are replayed instead of the original database commands.

The statistics module is configured to gather performance statistics in response to the replayed database commands and configured to send requested performance statistics to one or more autonomic consumer applications.

A system of the present invention is also presented to autonomically analyze a database management system. The system, in one embodiment, includes a database system, a datastore, and a self optimization tool for optimizing the configuration of the database system. In one embodiment, the self-optimization tool may include all of the modules discussed above with respect to the apparatus including a recorder module, a schedule module, a workload playback module, and a statistics module.

The workload playback module, in one embodiment, may be further configured to block user connections to the database system during the duration of the playback window.

A method of the present invention is also presented for autonomically analyzing a database management system. The method in the disclosed embodiments substantially includes the steps necessary to carry out the functions presented above with respect to the operation of the described apparatus and system.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system to autonomically analyze a database management system in accordance with the present invention;

FIG. 2 is a schematic flow chart diagram illustrating one embodiment of a method for autonomically analyzing a database management system in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

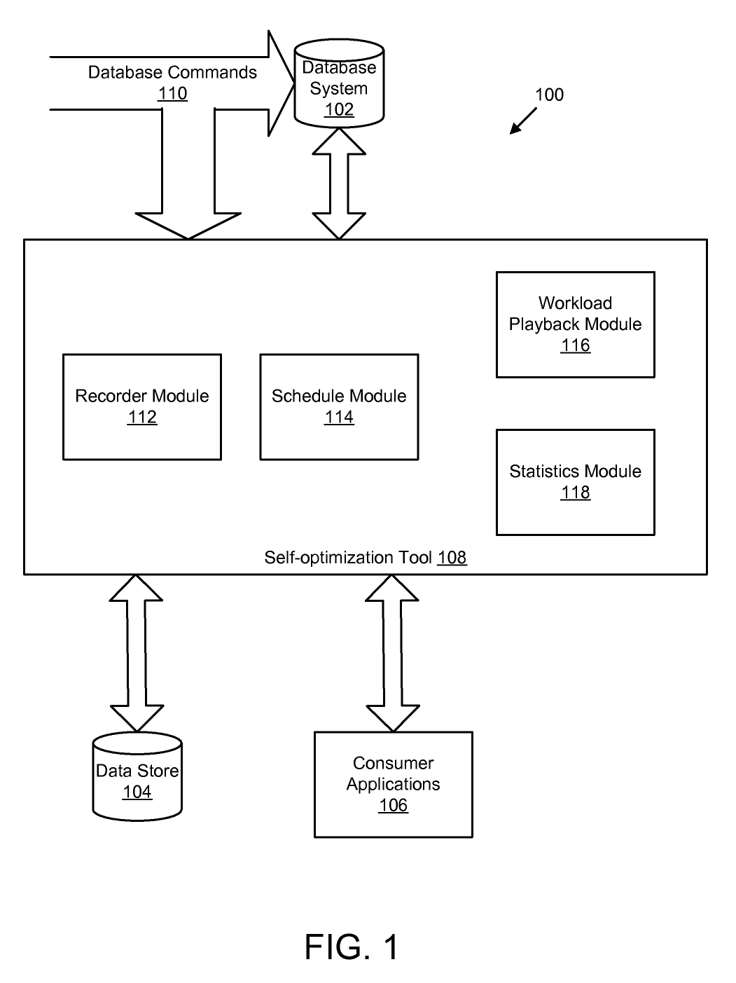

FIG. 1 depicts a system 100 to autonomically analyze a database management system (DBMS). The system includes a database management system 102, a datastore 104, consumer applications 106, and a self-optimization tool 108.

The database management system 102 may include one or more databases in electronic communication with one another. As will be recognized by one skilled in the art, a database is a combination of computer hardware and software for storing and retrieving data in an organized way. The database management system 102 may also include software for managing and querying the data stored within the database management system 102. Such software is referred to as a DBMS. One example of a DBMS is DB2® from IBM of White Plains, N.Y. which is a relational DBMS. However, other types of DBMSs can also be used. The database management system 102 receives database commands 110 from various computer programs and applications that are configured to utilize the database management system 102. The database commands 110 may include commonly known database commands 110 from the various query languages (such as SQL), including but not limited to operations such as store, delete, retrieve, and query.

The datastore 104 may include one or more computer storage devices for storing electronic data. In various embodiments, the datastore 104 may include a database, a harddrive, a magnetic storage device, a flash drive, or other storage device recognized by those of skill in the art. However, the datastore 104, in various embodiments, does not require a separate hardware instance to operate properly. For example, in one embodiment, a simple text file of database commands 110 may act as the datastore 104. With regard to the present invention, the datastore 104 is where the system 100 records the database commands 110 for playback at a later time.

The consumer applications 106 may include computer programs and software applications that communicate with and optimize the database management system 102. One example of a consumer application 106 is an online index advisor. Other advisors and/or optimizers, either autonomic or non-autonomic may serve as the consumer application 106. In one embodiment, the consumer applications 106 may store or retrieve data from the database management system 102. The consumer applications 106 may also send queries to the database management system 102 for collecting data relevant to each particular consumer application 106.

Additionally, a consumer application 106 may, in one embodiment, request a particular set of database performance statistics that are relevant to that particular consumer application 106. In various embodiments, the consumer applications 106 may include functions such as optimizing the efficiency of access plans, optimizing the memory and configuration of the database management system 102, searching of queries' selectivity spaces for parametric query optimizers, as well as other desired optimization programs as will be recognized by those of skill in the art.

The self-optimization tool 108 includes a recorder module 112, a schedule module 114, a workload playback module 116, and a statistics module 118. In one embodiment, the self-optimization tool 108 may be embedded within the database management system 102 such as within a DBMS. The self-optimization tool 108 is configured to autonomically analyze a DBMS during an optimal workload window and return the results to the consumer applications 106 in the form of performance statistics. Generally, the self-optimization tool 108 replays the database commands 110, as recorded in the datastore 104, during an optimal playback window such that performance statistics are returned to the consumer applications 106 responsible for optimizing the database management system 102. Replaying the pre-recorded database commands 110 provides realistic performance statistics because the actual DBMS 102 is used rather than a model. In this manner, the consumer applications can then autonomically optimize the database management system 102. In certain embodiments, the self-optimization tool 108 does not include a recorder module 112, instead database commands are predefined in the datastore 104. The datastore 104 may be populated using various other tools besides the recorder module 112. In certain embodiments, the datastore 104 may comprise a simple user generated text file of database commands that include suitable delimiters.

The recorder module 112 is configured to record database commands in the datastore 104 as the database commands 110 are issued such that the recorder module imposes minimal performance effects on the database management system 102. By storing the database commands 110 rather than gathering performance statistics at runtime during normal operations, the self-optimization tool 108 significantly reduces the impact on the database management system 102 performance as seen by a user. The recorder module 112 records the database commands 110 in the datastore 104 so as to facilitate replay of the database commands 110 at a later time.

The schedule module 114 is configured to determine an optimal playback window for replaying the recorded database commands 110. In one embodiment, the schedule module 114 may determine an optimal playback window based on whether or not the current database management system 102 usage is at or below a set percentage of the peak usage. In other words, when usage of the database management system 102 is low, the schedule module 114 may determine that the recorded database commands 110 may be replayed.

In another embodiment, the schedule module 114 may determine an optimal playback window based on a previous record of the database management system 102 usage. For example, the schedule module 114 may predict a particular time of day when usage is the lowest based on previous usage records, such as at night, so that the replay of the database commands 110 can take place during that period. Regardless of the internal mechanism used for scheduling, the primary purpose of the schedule module is to minimize the effect of the self-optimization tool 108 on the database management system 102 by determining an appropriate time for replaying the database commands 110.

The workload playback module 116 is configured to read the recorded database commands 110 from the datastore 104 and replay the database commands 110 during the optimal playback window determined by the schedule module 114. In one embodiment, read-only database commands 110 may be run against actual data within the database management system 102, whereas database commands 110 that change the data, such as a write command, may rely on a query optimizer's estimates of the performance effects of those database commands 110. In an alternate embodiment, database commands 110 that change the data may be replayed against a copy of the data such that changing the copied data will not affect the usual operations of the database management system 102. While database commands 110 are replayed, the replayed commands are preferably not recorded by the recorder module 112.

In a further embodiment, the workload playback module 116 is configured to filter the database commands 110 in response to user-defined preferences such that only relevant database commands 110 are replayed. For example, a user may be interested in statistics such as compile times, estimated or actual execution times, or potentially more advanced metrics such as disk usage patterns which can be collected for either individual queries or aggregated across sets of queries. Furthermore, filtering the database commands 110 may include limiting the replay duration via sampling or some other method. Thus, a user can specify which performance statistics they are interested in so that unnecessary data gathering can be avoided.

In one embodiment, the workload playback module 116 may be further configured to receive statistic requests from a consumer application 106 such that relevant performance statistics are returned to that particular consumer application 106. For example, each of the different consumer applications 106 is likely to request statistics that are useful in optimizing that particular application's operations. Thus, based on the received statistic requests, the workload playback module 116 returns back relative information to the respective consumer applications 106. In this manner, the consumer applications 106 can autonomically retrieve performance statistics relevant to their own operations.

In yet a further embodiment, the workload playback module 116 is configured to aggregate requests from the consumer applications 106 such that multiple requests are serviced by a single replay of the database commands 110 so that the adverse performance effects of the self-optimization tool 108 can be reduced even further. For example, if multiple consumer applications 106 request statistics related to the same database commands 110, those database commands 110 may, in one embodiment, be replayed only once for statistics gathering, and the relevant statistics will be returned to each of the requesting consumer applications 106. By aggregating requests from the consumer applications 116, the workload playback module 116 is able to prevent the need for multiple playbacks of a single group of database commands 110.

In yet another embodiment, the workload playback module 116 may be configured to manipulate the database commands 110 such that modified database commands 110 are replayed instead of the original database commands. For example, a parametric query may rely on an attribute that is provided at runtime. Thus, the workload playback module 116, in one embodiment, may utilize an attribute other than the attribute used in the original play of the database commands 110 such that a different statistical result is attained. In another embodiment, the workload playback module 116 may manipulate the database commands 110 by randomizing the order of the database commands 110 or by selecting a subset of the database commands 110 for replay. As will be recognized by one skilled in the art, numerous manipulations of the database commands 110 are possible and may be implemented in accordance with the present invention.

In one embodiment, the workload playback module 116 may be further configured to block user connections to the database management system 102 during the duration of the playback window. Such an operation may be used upon startup of a database management system 102 so as to pre-seed access plan caches or to re-optimize the database management system 102 after a configuration has changed. Of course, user connections may also be blocked simply to gather performance statistics based on previously recorded database commands, where active users may affect the operations of the self-optimization tool 108.

The statistics module 118 is configured to gather performance statistics in response to the replayed database commands 110, and is further configured to send requested performance statistics to one or more autonomic consumer applications 106. Thus, the statistics module 118 gathers the requested performance data and makes it available to the consumer applications 106 by analyzing the database management system's response 102 to the replayed database commands 110. Once the statistics are returned to the consumer applications 106, the consumer applications 106 autonomically determine how best to optimize the database management system 102.

If desired, greater flexibility can be achieved by allowing the consumer applications 106 to communicate with the workload playback module 116 through the use of call backs so as to provide feedback to the self-optimization tool 108 and allow combinatorial algorithms that pursue multiple configurations of the database management system 102 in order to determine an optimal configuration. In this manner, the multiple iterations of the playback of the database commands 110 may be used to more accurately optimize the database management system 102.

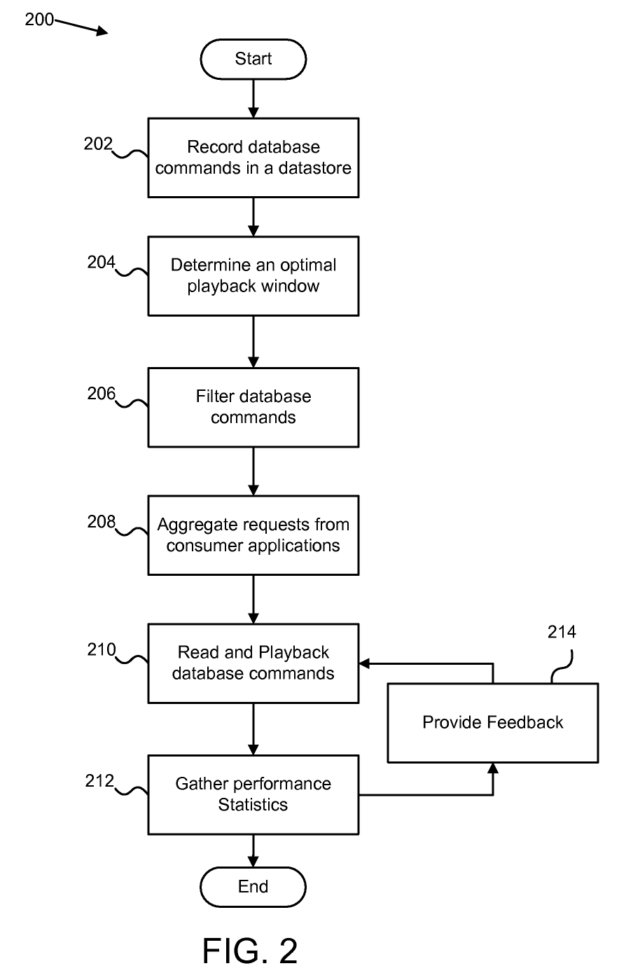

FIG. 2 is a schematic flow chart diagram illustrating one embodiment of a method 200 for autonomically analyzing a database management system 102 in accordance with the present invention. The method 200 includes substantially the same modules described above with regard to FIG. 1.

The method 200 begins when the recorder module 112 records 202 database commands 110 in a datastore 104. The database commands 110 are stored 202 with minimal imposition on the performance of the database management system 102. Next, a schedule module 114 determines 204 an optimal playback window for replaying the recorded database commands 110. The optimal playback window allows the database commands 110 to be replayed without significantly affecting the usage of the database management system 102. In one embodiment, this is accomplished by determining 204 a playback window when usage of the database management system 102 is relatively low.

In one embodiment, a workload playback module 116 filters 206 the database commands 110 in response to user-defined preferences such that only relevant database commands 110 are replayed. In a further embodiment, the workload playback module 116 may receive statistic requests from a consumer application 106 such that relevant performance statistics are returned to that consumer application 106. Additionally, the workload playback module 116 may aggregate 208 requests from consumer applications 106 such that multiple requests are serviced by a single replay of the database commands 110. In this manner, the workload playback module 116 minimizes the workload of the self-optimization tool 108 by allowing the replay of database commands 110 to be limited to relevant database commands 110.

Next, the workload playback module 116 reads 210 the recorded database commands 110 from the datastore 104 and replays 210 the database commands 110 during the optimal playback window determined by the schedule module 114.

A statistics module 118 then gathers 212 performance statistics in response to the replayed database commands 110 and sends requested performance statistics to one or more autonomic consumer applications 106. In one embodiment, the consumer applications 106 may then provide 214 feedback to the workload playback module 116 where more iterations of the replay of database commands 110 are needed to optimize the database management system 102. In one embodiment, subsequent iterations of the replay of database commands 110 may include changes to the attributes on which the database commands 110 rely. For example, parametric queries may rely on attributes that are supplied at runtime, so subsequent replays of the database commands 110 may change the parameter attribute to new values within a supplied range of value.

The consumer applications 106 may then autonomically optimize the database management system 102 based on the performance statistics. The method 200 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to autonomically analyze a database management system (DBMS) during an optimal workload window, the apparatus comprising:
a recorder module configured to record database commands in a datastore as the database commands are issued such that the recorder module imposes minimal performance effects on the DBMS;
a schedule module configured to determine an optimal playback window for replaying the recorded database commands;
a workload playback module configured to read the recorded database commands and replay the database commands during the determined optimal playback window; and
a statistics module configured to gather performance statistics in response to the replayed database commands and configured to send requested performance statistics to one or more autonomic consumer applications.

2. The apparatus of claim 1, wherein the workload playback module is further configured to filter the database commands in response to user-defined preferences such that only relevant database commands are replayed.

3. The apparatus of claim 1, wherein the workload playback module is further configured to aggregate requests from the consumer applications such that multiple requests are serviced by a single replay of the database commands.

4. The apparatus of claim 1, wherein the workload playback module is further configured to manipulate the database commands such that modified database commands are replayed instead of the original database commands.

5. The apparatus of claim 1, wherein the workload playback module is further configured to receive statistic requests from a consumer application such that relevant performance statistics are returned to that consumer application.

6. A system to autonomically analyze a database management system (DBMS) during an optimal workload window, the system comprising:
a database system;
a datastore; and
a self-optimization tool for optimizing the configuration of the database system comprising:
a recorder module configured to record database commands in a datastore as the database commands are issued such that the recorder module imposes minimal performance effects on the DBMS;
a schedule module configured to determine an optimal playback window for replaying the recorded database commands and further configured to receive statistic requests from a consumer application such that relevant performance statistics are returned to that consumer application;
a workload playback module configured to read the recorded database commands and replay the database commands during the determined optimal playback window and further configured to filter the database commands in response to user-defined preferences such that only relevant database commands are replayed; and
a statistics module configured to gather performance statistics in response to the replayed database commands and configured to send requested performance statistics to one or more autonomic consumer applications.

7. The system of claim 6, wherein the workload playback module is further configured to aggregate requests from the consumer applications such that multiple requests are serviced by a single replay of the database commands.

8. The system of claim 6, wherein the workload playback module is further configured to block user connections to the database system during the duration of the playback window.
